(19) United States
(12) Patent Application Publication
(10) Pub. No.: US 2025/0087939 A1
(43) Pub. Date: Mar. 13, 2025

(54) OPTICAL MODULE WITH DETACHABLE PULL TAB AND RELEASE MECHANISM OF THE SAME

(71) Applicant: Global Technology Inc., Ningbo (CN)

(72) Inventors: Taotao YE, Ningbo (CN); Qilin HONG, Ningbo (CN); Kejun CHEN, Ningbo (CN)

(21) Appl. No.: 18/589,321

(22) Filed: Feb. 27, 2024

(30) Foreign Application Priority Data
Sep. 8, 2023 (CN) 202311159821.5

(51) Int. Cl. H01R 13/633; G02B 6/42

(52) U.S. Cl. CPC H01R 13/6335; G02B 6/4278

(57) ABSTRACT

An optical module includes a housing and a release mechanism. The release mechanism includes a fastening component and a pull tab. The fastening component is movably disposed on the housing and detachably fastenable with a cage. The pull tab is detachably and pivotally disposed on the fastening component.

### CROSS-REFERENCE TO RELATED APPLICATIONS

This application claims priority under 35 U.S.C. § 119(a) on Patent Application No(s). 202311159821.5 filed in China on Sep. 8, 2023, the entire contents of which are hereby incorporated by reference.

### BACKGROUND

### 1. Technical Field

The present disclosure relates to optical communication, more particularly to a pluggable optical module and a release mechanism of the same.

### 2. Related Art

Optical modules are generally installed in electronic communication facilities in modern high-speed communication networks. In general, an optical module including a combination of an optical emitter as well as some related optical components may be referred as a transmitter optical sub-assembly (TOSA), an optical module including a combination of an optical receiver as well as some related optical components may be referred as a receiver optical sub-assembly (ROSA), and an optical module including the optical emitter, the optical receiver as well as a wavelength-division multiplexing (WDM) filter may be referred as a bi-directional optical sub-assembly (BOSA).

To facilitate the flexible design of an electronic communication facility and reduce the maintenance burden, various form factors have been made available for different communication rates. These form factors include but are not limited to 10G XFP, 40G QSFP (Quad Small Form Factor Pluggable), 100G QSFP28, 400G QSFP-DD, 800G QSFP-DD (Double Density), 1.6T OSFP (Octal Small Form Factor Pluggable), and 3.2T CPO (Co-Packaged Optics).

### SUMMARY

According to one aspect of the present disclosure, an optical module is provided to be inserted into a cage in a pluggable manner. The optical module includes a housing and a release mechanism. The release mechanism includes a fastening component and a pull tab. The fastening component is movably disposed on the housing and detachably fastenable with the cage. The pull tab is detachably and pivotally disposed on the fastening component.

According to another aspect of the present disclosure, a release mechanism for optical module includes a fastening component and a pull tab. The fastening component is detachably fastenable with a cage. The pull tab is detachably and pivotally disposed on the fastening component.

### BRIEF DESCRIPTION OF THE DRAWINGS

The present disclosure will become more fully understood from the detailed description given below and the accompanying drawings which are given by way of illustration only and thus are not intending to limit the present disclosure and wherein:

FIG. 1 is a perspective view of a cage and an optical module according to one embodiment of the present disclosure;

FIG. 2 is a partially enlarged view of a cross section of the optical module in FIG. 1 with a fastening component at a fastening position;

FIG. 3 is a partially enlarged view of the cross section of the optical module in FIG. 1 with the fastening component at a releasing position;

FIG. 4 is an exploded view of the optical module in FIG. 1;

FIG. 5 through FIG. 7 are schematic views of assembling a release mechanism of the optical module in FIG. 4;

FIG. 8 is a perspective view of the optical module in FIG. 1 with a pull tab at a horizontal state;

FIG. 9 is a partially side view of the optical module in FIG. 8;

FIG. 10 is a perspective view of the optical module in FIG. 8 with the pull tab at an upright state; and

FIG. 11 is a partially side view of the optical module in FIG. 10.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

In general, a release mechanism is used for securely fixing the optical module to the cage, and the optical module can be released and removed from the cage by the release mechanism when necessary. A conventional release mechanism is provided with a pull tab served as a handle for a user, and the pull tab may be formed by injection molding on an arm configured to fastened with the cage. Since the pull tab is fixed to the arm, the pull tab may obstruct the user's operation to plug optical fiber or jumper into or remove the same from the optical module. Also, the pull tab frequently touched by the user may easily become dirty or damaged. However, the entire release mechanism will be replaced when replacing the pull tab with a new one, such that the replacement is costly.

According to one aspect of the present disclosure, due to a design in which the detachable and pivotable pull tab is provided on the fastening component, the fastening component and the pull tab can be separable objects. The dirty or damaged pull tab can be replaced without moving or detaching the fastening component, and thus it is helpful to reduce the costs for maintenance of the release mechanism and simplify the process of repairing the release mechanism. Furthermore, the pull tab can be pivoted upward so as to facilitate the operation of plugging optical fibers or jumpers into the port of the housing or removing the same out of the port.

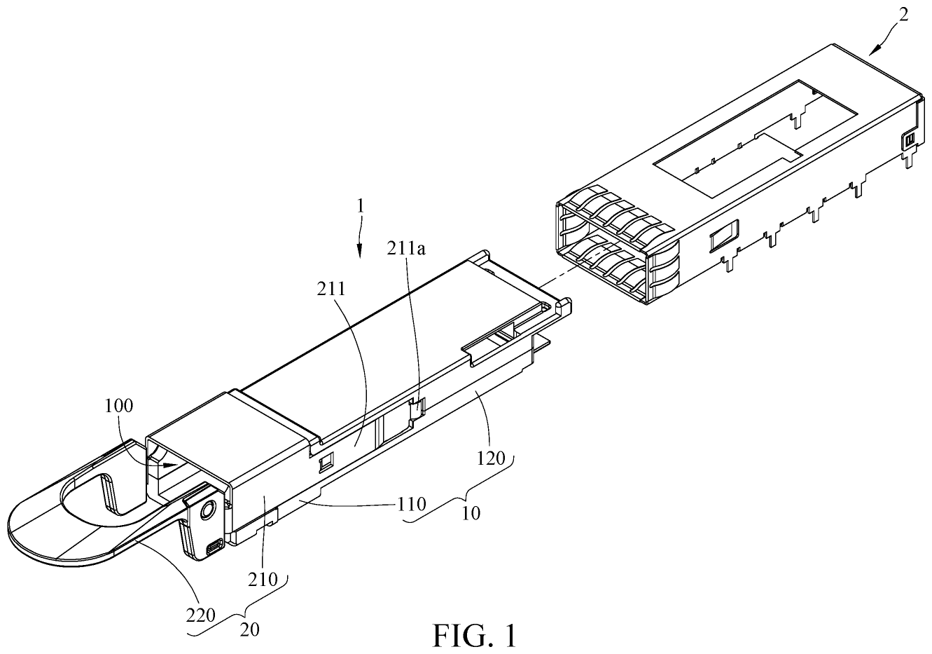

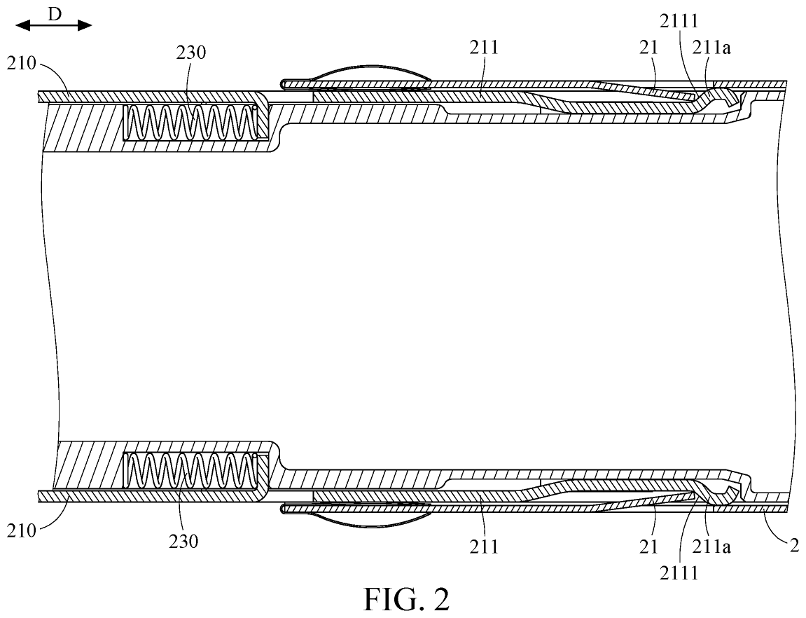

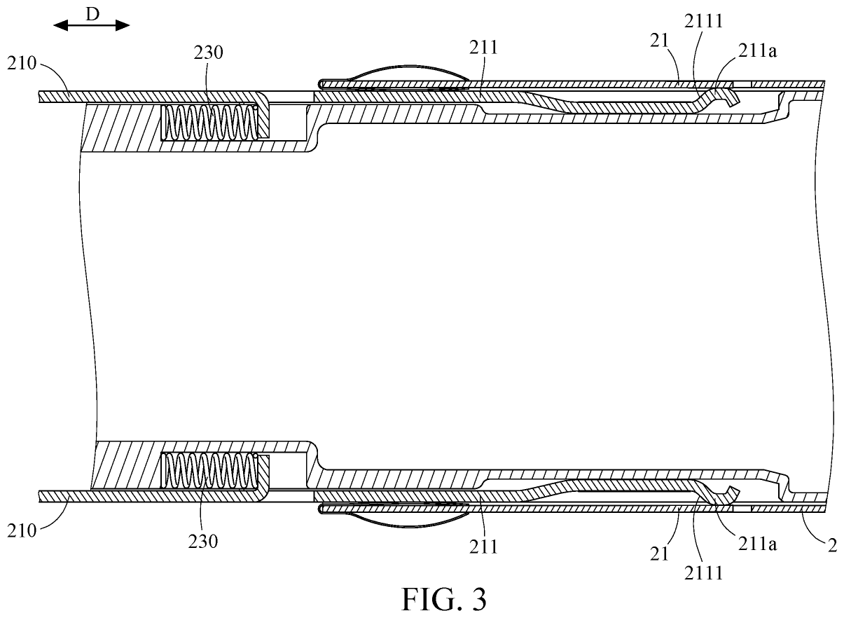

Please refer to FIG. 1 through FIG. 3. FIG. 1 is a perspective view of a cage and an optical module according to one embodiment of the present disclosure, FIG. 2 is a partially enlarged view of a cross section of the optical module in FIG. 1 with a fastening component at a fastening position, and FIG. 3 is a partially enlarged view of the cross section of the optical module in FIG. 1 with the fastening component at a releasing position. In this embodiment, an optical module 1 can be inserted into a cage 2 in pluggable manner. The optical module 1 may include a housing 10 and a release mechanism 20.

The housing 10 may include a head portion 110 and an insertion portion 120 connected to each other. The insertion portion 120 is configured to be inserted into the cage 2. The head portion 110 may include a port 100 for receiving optical connector (not shown in the drawings). Said optical connector may be an optical fiber or a jumper. Moreover, the housing 10 may be a single piece, or the housing 10 may include an upper case and a lower case assembled together.

The release mechanism 20 may include a fastening component 210 and a pull tab 220. The fastening component 210 may include an arm 211, and the arm 211 is movably disposed on an outer lateral surface of the housing 10. The fastening component 210 may include two arms 211 respectively at opposite sides of the housing 10 in this embodiment, while it is noted that the present disclosure is not limited by the specific configuration and shape of the fastening component 210. In some other embodiments, the fastening component 210 may include single arm 211. The arm 211 of the fastening component 210 may include a fastening portion 211a corresponding to a slot on the cage 2. The fastening component 210 can be moved with respect to the housing 10 so as to fasten the fastening portion 211a with the slot on the cage 2. The pull tab 220 may be disposed on the fastening component 210.

In this embodiment, the release mechanism 20 may further include the same number of elastic component 230 as the arm 211. The elastic component 230 may be disposed on the housing 10 and constantly press against the fastening component 210.

The fastening component 210 may be moved with respect to the housing 10 in a releasing direction D to be at rather a fastening position (as shown in FIG. 2) and a releasing position (as shown in FIG. 3). Referring to FIG. 2, the elastic component 230 may press against the fastening component 210 so as to keep the fastening component 210 at the fastening position, and thus the fastening portion 211a is stably fastened with the cage 2. Therefore, the optical module 1 can be easily and reliably inserted into the cage 2.

As shown in FIG. 1 through FIG. 3, a user may move the fastening component 210 with respect to the housing 10 in the releasing direction D by pulling the pull tab 220. The fastening portion 211a may push a flexible arm 21 of the cage 2, causing the fastening portion 211a to slide along its slope 2111. The fastening portion 211a may bend the flexible arm 21 so as to move the fastening component 210 to the releasing position. When the pull tab 220 is continuously pulled along the releasing direction D, the insertion portion 120 of the housing 10 can be removed out of the cage 2.

Furthermore, the fastening component 210 may compress the elastic component 230 when it is at the releasing position. When the user releases the pull tab 220, the elastic potential stored in the elastic component 230 may move the fastening component 210 back to the fastening position.

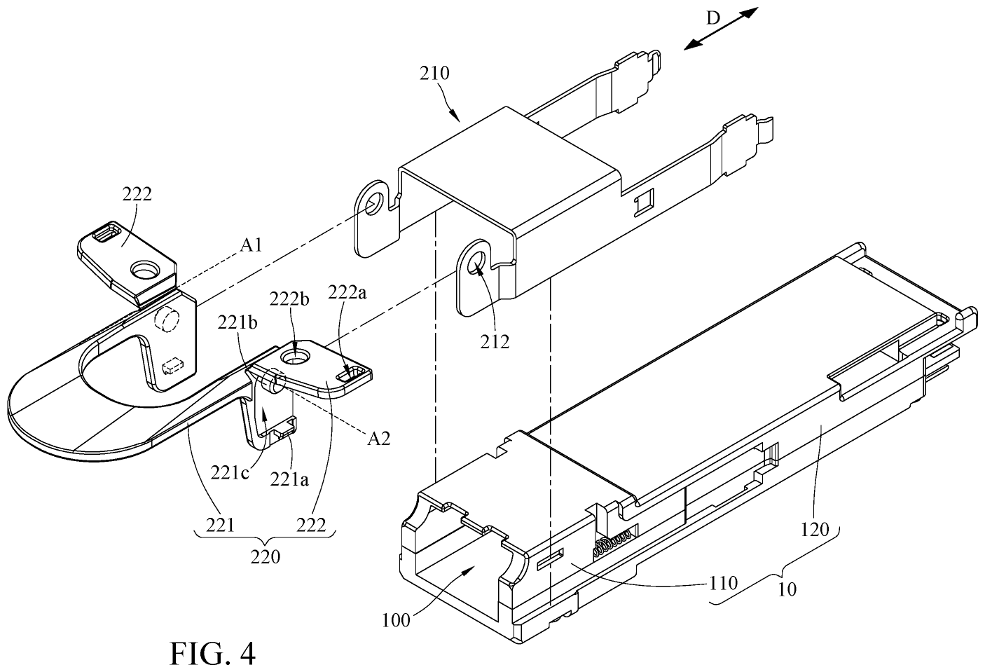

In this embodiment, the pull tab 220 may be detachably disposed on the fastening component 210. FIG. 4 is an exploded view of the optical module in FIG. 1. The pull tab 220 may include a main body 221 and at least one pivotal portion 222 pivotally connected to the main body 221. An axis A1 of the pivotal portion 222 may be substantially parallel to the releasing direction D of the fastening component 210. The main body 221 may include a first fastening structure 221a, and the pivotal portion 222 may include a second fastening structure 222a corresponding to the first fastening structure 221a. The first fastening structure 221a may be snapped with the second fastening structure 222a so as to detachably fasten the pull tab 220 with the fastening component 210. In this embodiment, the pull tab 220 may include two pivotal portions 222 at opposite sides of the fastening component 210, respectively, while it is noted that the present disclosure is not limited by the specific configuration and shape of the pull tab 220. In some other embodiments, the pull tab 220 may include single pivotal portion 222. Also, FIG. 4 exemplarily depicts that the first fastening structure 221a and the second fastening structure 222a are a combination of hook and buckle hole, while the present disclosure is not limited to the illustration in FIG. 4.

In this embodiment, the pull tab 220 may be pivotally disposed on the fastening component 210. As shown in FIG. 4, the fastening component 210 may include at least one insertion hole 212, and the main body 221 of the pull tab 220 may include the same number of shaft 221b as the pivotal portion 222. An axis A2 of the shaft 221b may be substantially orthogonal to the releasing direction D of the fastening component 210. The pull tab 220 may be pivotally disposed on the fastening component 210 by the shaft 221b disposed in the insertion hole 212.

In this embodiment, the pivotal portion 222 of the pull tab 220 may further include an opening 222b. When the first fastening structure 221a of the main body 221 is fastened with the second fastening structure 222a of the pivotal portion 222, the shaft 221b of the main body 221 may pass through the opening 222b.

In this embodiment, the main body 221 of the pull tab 220 may further include at least one recess 221c. The first fastening structure 221a of the main body 221 may be located outside the recess 221c, and the shaft 221b of the main body 221 as well as part of the fastening component 210 may be located in the recess 221c. The recess 221c is helpful to reduce the lateral thickness of the main body 221 of the pull tab 220.

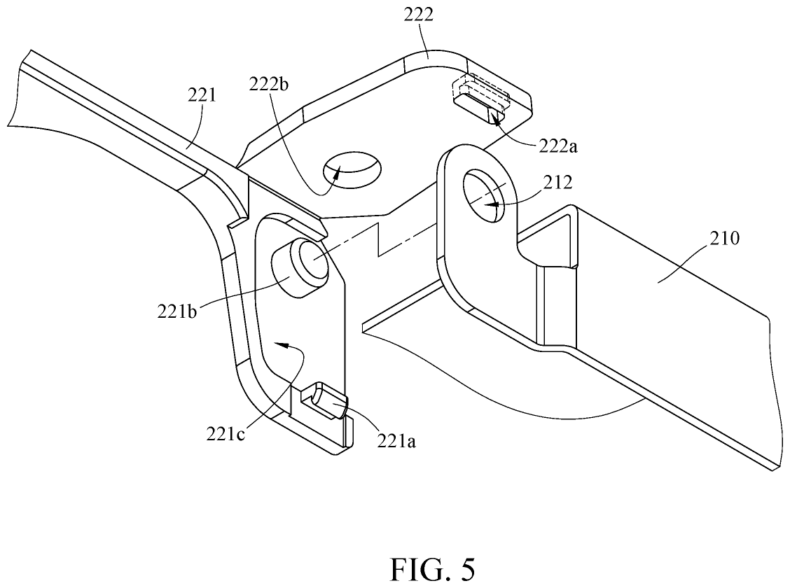

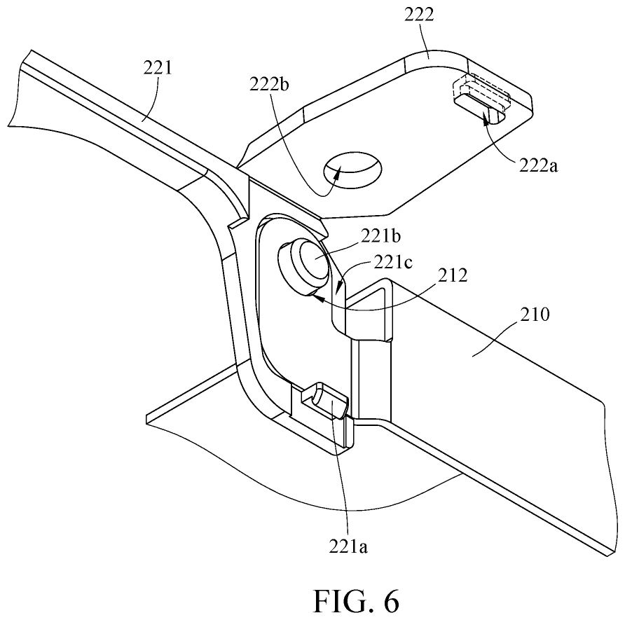

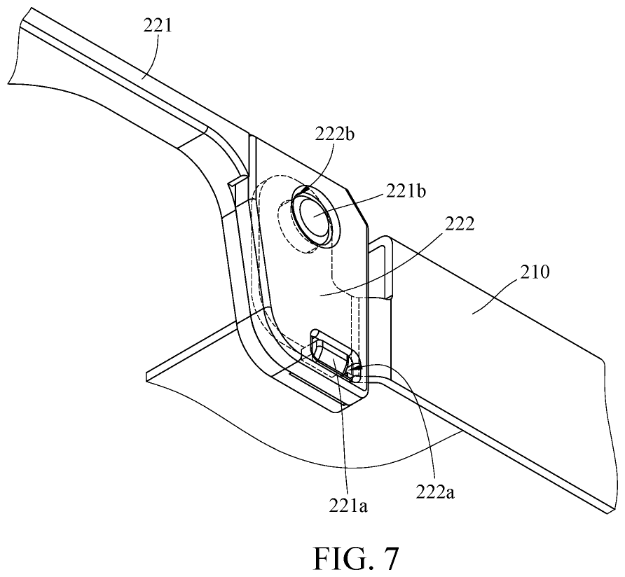

The following describes the assembling of the pull tab 220 with the fastening component 210. FIG. 5 through FIG. 7 are schematic views of assembling a release mechanism of the optical module in FIG. 4. As shown in FIG. 5 and FIG. 6, the shaft 221b of the main body 221 may be aligned with the insertion hole 212 of the fastening component 210. The shaft 221b is inserted into the insertion hole 212, such that the recess 221c of the main body 221 can receive an end of the fastening component 210. Then, as shown in FIG. 7, the pivotal portion 222 of the pull tab 220 is pivoted so as to fasten the first fastening structure 221a of the main body 221 with the second fastening structure 222a of the pivotal portion 222.

Due to a configuration that the detachable and pivotable pull tab 220 is provided on the fastening component 210, the fastening component 210 and the pull tab 220 can be two separable objects. The dirty or damaged pull tab 220 can be replaced without moving or detaching the fastening component 210, and thus it is helpful to reduce the costs for maintenance of the release mechanism 20 and simplify the process of repairing the release mechanism 20. In order to reduce the costs for maintenance, the pull tab 220 may be made of plastic material. In order to enjoy sufficient flexibility and service life, the fastening component 210 may be made of metal material. Moreover, the pull tab 220 can be pivoted upward so as to facilitate the operation of plugging optical fibers or jumpers into the port 100 of the housing 10 or removing the same out of the port 100.

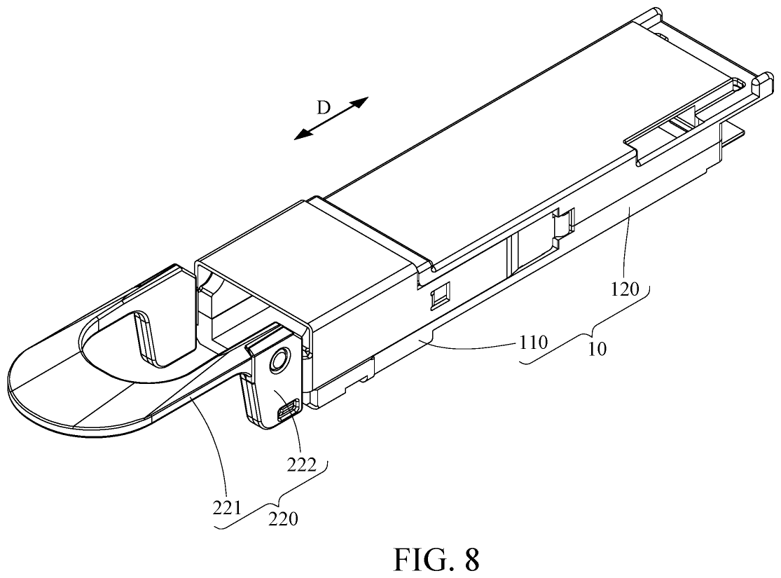

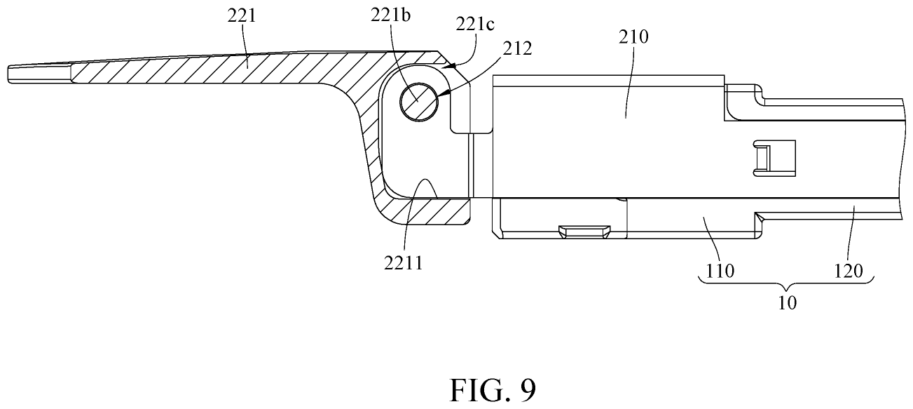

The pull tab 220 may be at a horizontal state. FIG. 8 is a perspective view of the optical module in FIG. 1 with a pull tab at a horizontal state, and FIG. 9 is a partially side view of the optical module in FIG. 8. When the pull tab 220 is at the horizontal state, the pull tab 220 can protect optical connectors, such as optical fibers or jumpers not shown in the drawings, from dust pollution. Furthermore, the pull tab 220 at the horizontal state can be pulled so as to remove the optical module 1 from the cage. For example, a user may hold the main body 221 of the pull tab 220 and pull the main body 221 along the releasing direction D of the fastening component 210. In this embodiment, a side wall 2211 of the recess 221c of the pull tab 220 may abut against the end of the fastening component 210 so as to keep the pull tab 220 at the horizontal state.

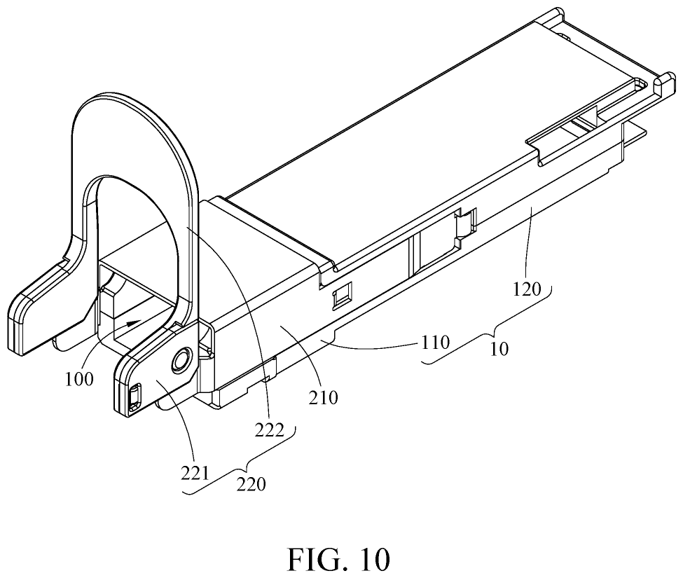

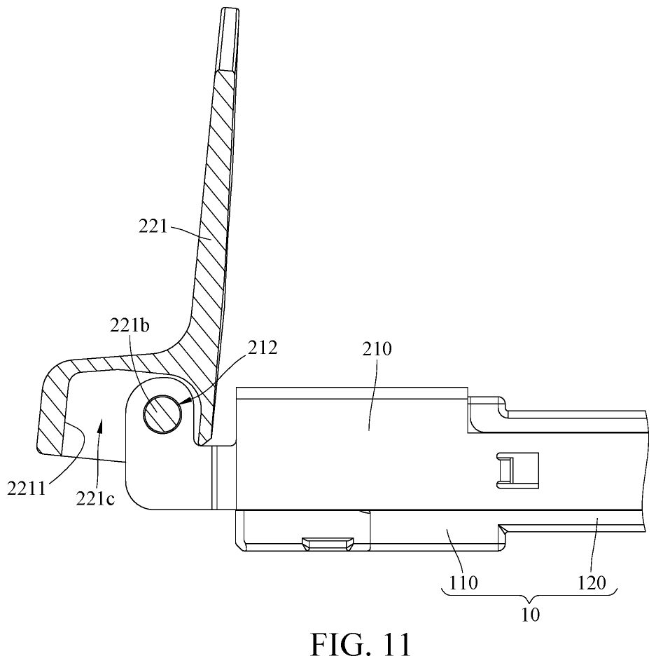

The pull tab 220 can be pivoted with respect to the fastening component 210 by a degree, such as 90 degrees, to be at an upright state from the horizontal state. FIG. 10 is a perspective view of the optical module in FIG. 8 with the pull tab at an upright state, and FIG. 11 is a partially side view of the optical module in FIG. 10. When the pull tab 220 is at the upright state, optical fibers or jumpers can be plugged into the port 100 of the housing 10 or removed out of the same. In this embodiment, the end of the fastening component 210 may support the main body 221 of the pull tab 220 so as to keep the pull tab 220 at the upright state, thereby allowing the installation or removal of optical fibers or jumpers without the demand to support the pull tab 220 by hands or external force.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. An optical module, configured to be inserted into a cage in pluggable manner, comprising:
a housing; and
a release mechanism, comprising:
a fastening component, movably disposed on the housing and detachably fastenable with the cage; and
a pull tab, detachably and pivotally disposed on the fastening component.

2. The optical module according to claim 1, wherein the fastening component is made of metal material, and the pull tab is made of plastic material.

3. The optical module according to claim 1, wherein the pull tab comprises a main body and a pivotal portion pivotally connected to the main body, the main body comprises a first fastening structure, the pivotal portion comprises a second fastening structure corresponding to the first fastening structure, and the first fastening structure is snapped with the second fastening structure so as to detachably fasten the pull tab with the fastening component.

4. The optical module according to claim 3, wherein the fastening component is movable with respect to the housing in a releasing direction so as to be released from the cage, and an axis of the pivotal portion of the pull tab is substantially parallel to the releasing direction.

5. The optical module according to claim 3, wherein the fastening component comprises an insertion hole, the main body of the pull tab comprises a shaft, and the pull tab is pivotally disposed on the fastening component by the shaft disposed in the insertion hole.

6. The optical module according to claim 5, wherein the pivotal portion of the pull tab comprises an opening, and when the first fastening structure is snapped with the second fastening structure, the shaft of the main body passes through the opening.

7. The optical module according to claim 5, wherein the fastening component is movable with respect to the housing in a releasing direction so as to be released from the cage, and an axis of the shaft of the pull tab is substantially orthogonal to the releasing direction.

8. The optical module according to claim 5, wherein the main body of the pull tab comprises a recess, the first fastening structure is located outside the recess, and the shaft as well as part of the fastening component are located in the recess.

9. The optical module according to claim 8, wherein the pull tab is pivotal with respect to the fastening component to be at either a horizontal state or an upright state, a side wall of the recess of the pull tab abuts against the fastening component so as to keep the pull tab at the horizontal state, and the fastening component supports the main body of the pull tab so as to keep the pull tab at the upright state.

10. A release mechanism for pluggable optical module, comprising:
a fastening component, detachably fastenable with a cage; and
a pull tab, detachably and pivotally disposed on the fastening component.

11. The release mechanism for pluggable optical module according to claim 10, wherein the fastening component is made of metal material, and the pull tab is made of plastic material.

12. The release mechanism for pluggable optical module according to claim 10, wherein the pull tab comprises a main body and a pivotal portion pivotally connected to the main body, the main body comprises a first fastening structure, the pivotal portion comprises a second fastening structure corresponding to the first fastening structure, and the first fastening structure is snapped with the second fastening structure so as to detachably fasten the pull tab with the fastening component.

13. The release mechanism for pluggable optical module according to claim 12, wherein the fastening component comprises an insertion hole, the main body of the pull tab comprises a shaft, and the pull tab is pivotally disposed on the fastening component by the shaft disposed in the insertion hole.

14. The release mechanism for pluggable optical module according to claim 13, wherein the pivotal portion of the pull tab comprises an opening, and when the first fastening structure is snapped with the second fastening structure, the shaft of the main body passes through the opening.

15. The release mechanism for pluggable optical module according to claim 13, wherein the main body of the pull tab comprises a recess, the first fastening structure is located outside the recess, and the shaft as well as part of the fastening component are located in the recess.

16. The release mechanism for pluggable optical module according to claim 15, wherein the pull tab is pivotal with respect to the fastening component to be at either a horizontal state or an upright state, a side wall of the recess of the pull tab abuts against the fastening component so as to keep the pull tab at the horizontal state, and the fastening component supports the main body of the pull tab so as to keep the pull tab at the upright state.
